(19) United States
(12) Patent Application Publication
(10) Pub. No.: US 2013/0108271 A1
(43) Pub. Date: May 2, 2013

(54) SYNCHRONOUS CLOCKING FOR OPTICAL ORTHOGONAL FREQUENCY DIVISION MULTIPLEXING TRANSMISSION SYSTEMS

(71) Applicants: Jianming Tang, Chelmsford (GB); Roger Giddings, Tregarth (GB)

(72) Inventors: Jianming Tang, Chelmsford (GB); Roger Giddings, Tregarth (GB)

(73) Assignee: Bangor University, Bangor, Gynedd (GB)

(21) Appl. No.: 13/697,643

(22) PCT Filed: May 12, 2011
(86) PCT No.: PCT/EP2011/057684

§ 371 Date: Jan. 15, 2013

(30) Foreign Application Priority Data
May 13, 2010 (GB) 1008018.2

(51) Int. Cl. H04J 3/06; H04B 10/27

(52) U.S. Cl. CPC H04J 3/0638; H04B 10/27
USPC 398/66

(57) ABSTRACT

The present invention discloses a method for achieving optimised synchronous clock distribution of point-to-multipoint optical orthogonal frequency division multiplexed networks such that bandwidth sharing in both the time and frequency domain is possible without interference between users. The invention details how all clocked components in the network are synchronised such that no clock offset compensation is required anywhere in the network. Also the present invention discloses a method for optimisation of the synchronous clocking method to maximise the system bit error rate (BER) performance, furthermore the present invention discloses a method for implementing multiband-OOFDM where ONUs can easily select any OOFDM band for data reception providing network configuration flexibility.

### FIELD OF THE INVENTION

The present invention discloses a method for synchronously distributing a clock signal to all network elements in point-to-multipoint optical networks based on optical orthogonal frequency division multiplexing (OOFDM) transmission, by transmitting an auxiliary clock with the OOFDM signal from the network operator's OOFDM transceiver to multiple end-users' OOFDM transceivers. The invention also discloses a method for optimising system performance of the synchronously clocked network and implementing multi-band, point-to-multipoint OOFDM networks with band-selective ONUs.

### BACKGROUND OF THE INVENTION

All digital telecommunication systems require synchronisation between the clock signal used in the transmitter for signal generation and the clock signal used in the receiver for data recovery. The level of synchronisation required depends upon the transmission system. For widely implemented high speed optical transmission systems operating at data rates larger than 10 Gb/s, highly synchronised clocks are essential as the system performance depends significantly upon the ability to achieve a highly accurate and good quality receiver clock.

The receiver clock can be generated by either of two methods as described for example by Hanzo et al. (L. Hanzo, S. X. NG, T. KELLER and W. WEBB, “Quadrature Amplitude Modulation: From basics to adaptive trellis-Coded, Turbo-Equalised and Space-Time Coded OFDM, CDMA and MC-CDMA Systems, John Wiley & Sons, Ltd, 2004).
1. In asynchronous clocking, the receiver employs a highly accurate free-running oscillator to minimise the offset between the transmitter and receiver clocks. A training sequence must be sent at sufficiently frequent periods to allow the receiver to determine the offset between the receiver clock and the transmitter clock, the receiver then compensates for this offset when performing the data recovery as in GSM, 3G mobile phone systems for example, or in packet based communication systems, the receiver may be able to tolerate the clock frequency offset and only compensate the clock phase offset during the packet period as in W-LAN for example.
2. In synchronous clocking, the clock timing information is encoded within the transmitted data signal which the receiver extracts. The extracted clock signal generally suffers from phase noise or jitter. It must therefore be cleaned up by use of a phase-locked-loop (PLL). The PLL controls the frequency of a voltage-controlled-oscillator (VCO) to provide a clean low jittered clock signal having its frequency locked to that of the highly jittered clock signal extracted from the received signal as in SONET/SDH optical systems for example.

In optical transmission systems based on Optical Orthogonal Frequency Division Multiplexing (OOFDM), the receiver must generate a clock for use as a sampling clock for the analogue-to-digital converters (ADCs) to sample the received analogue signal. In addition the receiver must generate a suitably synchronised clock to drive the digital DSP hardware. The mismatch between the sampling clock used in the transmitter by the digital-to-analogue converter (DAC) to generate the analogue signal and the sampling clock used in the receiver to sample and digitise the received signal is called the sampling clock offset (SCO). The level of SCO has a significant impact on system performance and should therefore be minimised to achieve optimum performance.

In OOFDM transmission systems, traditional asynchronous clocking is difficult to implement and suffers from four main disadvantages:

a) Oversampling may be required to allow for the clock offset compensation. This increases the bandwidth requirements on the employed analogue-to-digital converters (ADC).

b) The compensation must be performed individually for each subcarrier thereby increasing complexity with increasing number of subcarriers.

c) The SCO compensation must be performed using digital signal processing (DSP) which adds complexity and cost to the OOFDM receiver.

d) Asynchronous clocking is not suitable for point-to-multipoint OOFDM networks which require synchronised end-user transceivers to allow bandwidth sharing in the time and frequency domains.

A synchronous clocking solution without the need for DSP is therefore preferred for OOFDM systems. Such a technique has been described in prior art document EP-A-2073474 which disclosed, in general terms, a method for simplifying OOFDM transmission by eliminating the use of DSP to clock the receiver by locking the frequencies used in the transmitter for the digital-to-analogue conversion of an inverse Fourier transform data signal to those of the analogue-to-digital conversion of the received optical OFDM signal in the receiver. This was achieved by adding a clock signal to the transmitted data signal and by restoring this clock signal in the receiver prior to any signal processing. The auxiliary clock signal recovered at the receiving end served solely as a sampling frequency for the analogue-to-digital conversion. The disclosure did not provide any detailed steps for implementing and optimising the clock signal and was specified only for the case of point-to-point links.

### BRIEF DESCRIPTION OF THE DRAWINGS

FIG. 1(a) is a basic diagram of the downstream link in a synchronously clocked point-to-multipoint OOFDM system.

FIG. 1(b) is a detailed diagram of the OLT transmitter shown in FIG. 1(a).

FIG. 1(c) is a detailed diagram of the ONU receiver shown in FIG. 1(a).

FIG. 2 represents the electrical spectrum of the combined OOFDM data signal and the synchronisation clock signal in a baseband OOFDM transmission system.

FIG. 3 represents the electrical spectrum of the combined OOFDM multiband signal and the synchronisation clock signal where the clock frequency is (a) below all OOFDM bands, (b) above all OOFDM bands and (c) position between two OOFDM bands.

FIG. 4 (a-c) shows the experimental system setup used to demonstrate and optimise the synchronous clocking of an OOFDM system where (a) is the system setup, (b) is the OOFDM transmitter and (c) is the OOFDM receiver.

FIG. 5 shows the measured synchronisation region of the experimental system.

FIG. 6 shows the variation in system BER with OOFDM signal level.

FIG. 7 shows the BER performance curve for the optimised experimental system.

FIG. 8(a-g) shows various signal waveforms in the experimental system. FIG. 9 shows the electrical spectrum of the combined OOFDM signal and clock signal in the transmitter of the experimental system.

### SUMMARY OF THE INVENTION

It is an objective of the present invention to achieve synchronous clocking of point-to-multipoint OOFDM passive optical networks (PONs) achieving hybrid dynamic bandwidth sharing in the time domain through the allocation of timeslots and/or the frequency domain through the allocation of subcarriers.

It is also an objective of the present invention to provide a method for optimisation of the synchronous clocking method to maximise the system bit error rate (BER) performance.

It is also an objective of the present invention to show that by synchronising all network elements in point-to-multipoint OOFDM networks, multiband-OOFDM can be implemented where ONUs can easily select any OOFDM band for data reception.

In accordance with the present invention, any one of the foregoing objectives is achieved as described in the independent claims. Preferred embodiments are described in the dependent claims.

### DETAILED DESCRIPTION OF THE INVENTION

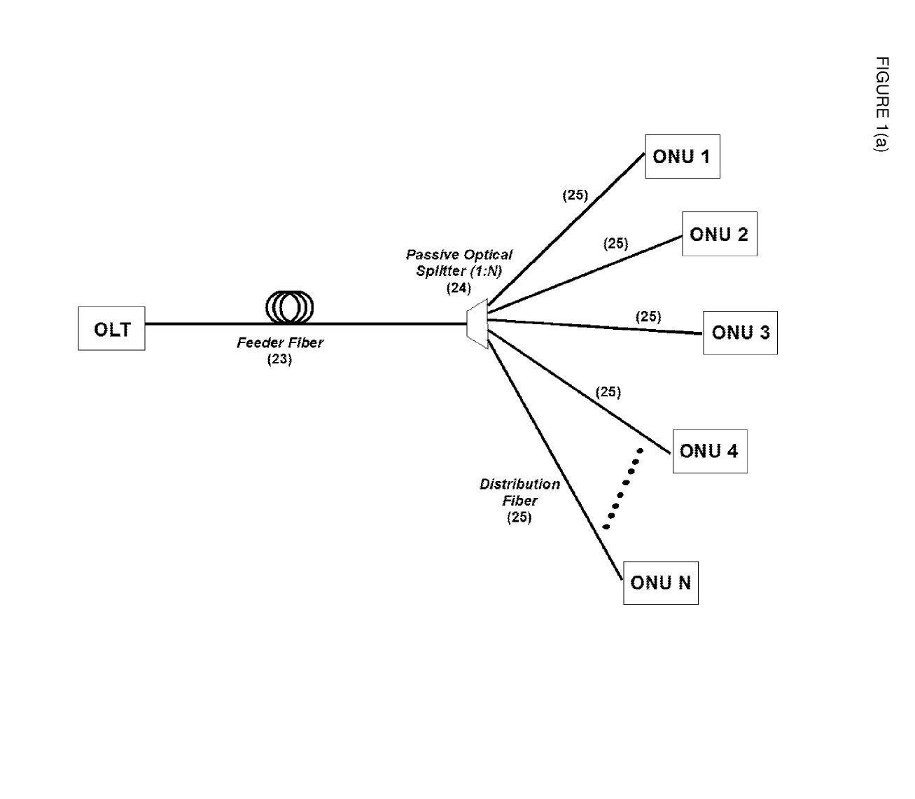

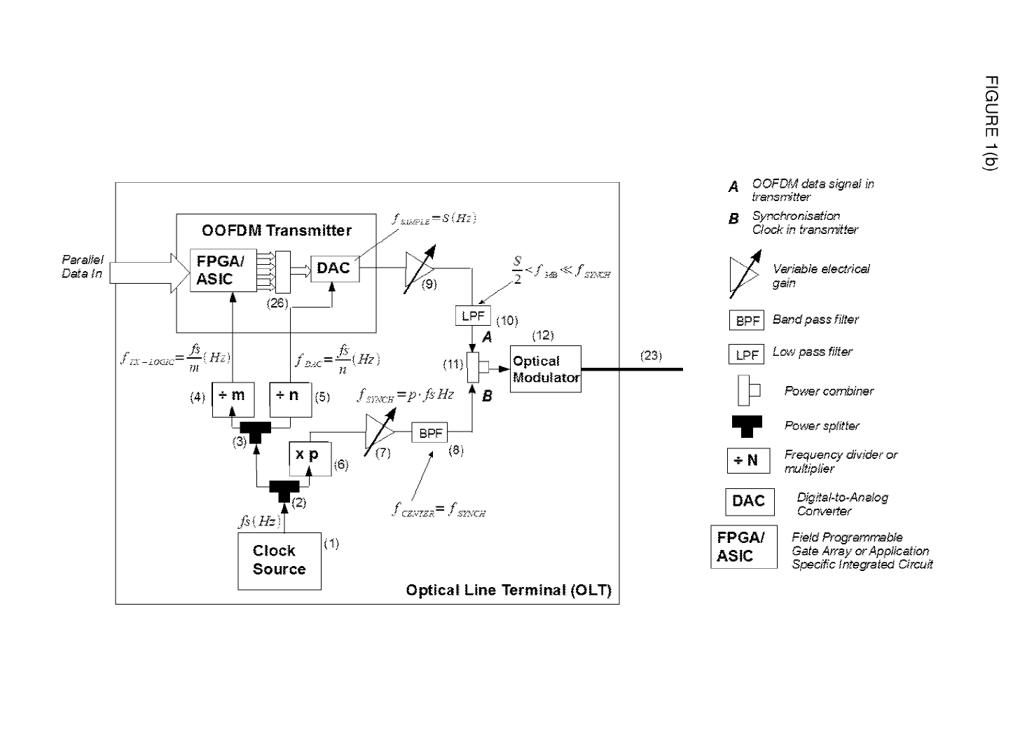

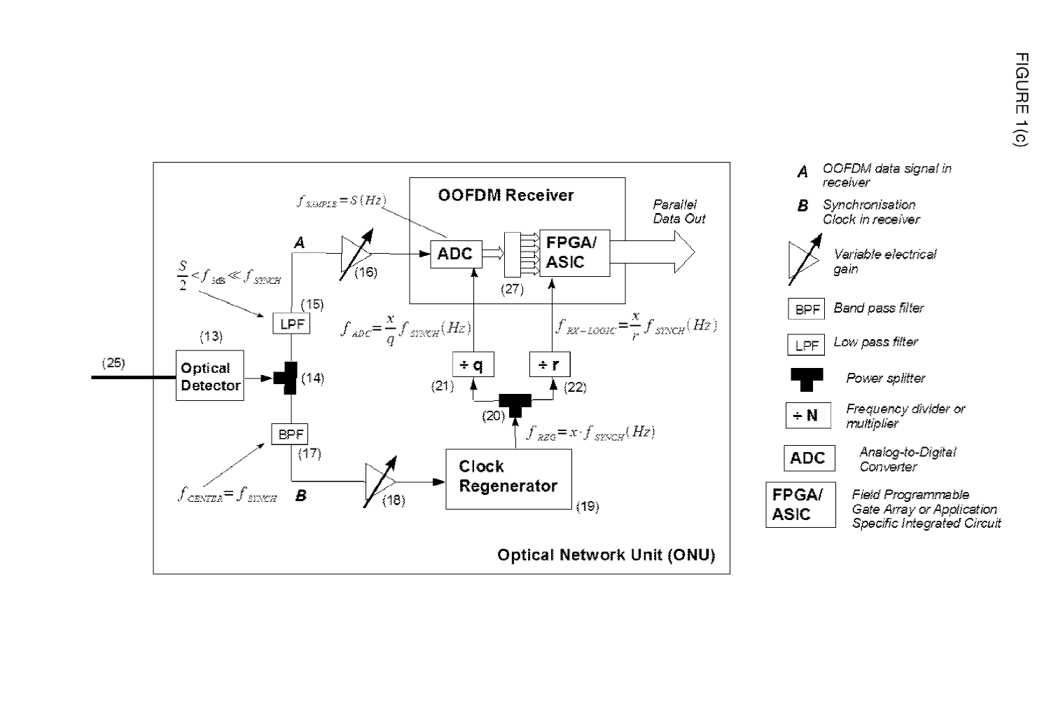

Accordingly, the present invention discloses a point-to-multipoint OOFDM transmission system, as represented in FIGS. 1(a), 1(b) and 1(c) that comprises:

1. transmitter systems each comprising:
a) a field-programmable gate array (FPGA) or application-specific integrated circuit (ASIC) including high speed digital logic-based DSP for OOFDM signal generation.
b) parallel to serial rate adapting interface between FPGA/ASIC and DAC
c) a digital to analogue converter (DAC);
d) a clock source;
e) an optical intensity modulator (electrical-to-optical converter)

2. receiver systems each comprising:
f) an optical detector (optical-to-electrical converter)
g) an analogue to digital converter (ADC)
h) serial to parallel rate adapting interface between ADC and FPGA/ASIC.
i) a field-programmable gate array (FPGA) or application-specific integrated circuit (ASIC) providing high speed digital logic-based DSP for OOFDM signal decoding.
j) a clock regenerator

The field-programmable gate array (FPGA) is a semiconductor digital logic device that can be configured as required by the equipment designer. It is programmed using a logic circuit diagram or source code in a hardware description language (HDL) to specify how the chip will work. It is used to implement any logical function that an application-specific integrated circuit (ASIC) could perform and it further has the ability to reconfigure the programmed functionality. It contains programmable logic components and a hierarchy of reconfigurable interconnects that allow the logic blocks to be “wired together”. Logic blocks can be configured to perform complex combinational or sequential functions and they also include hardwired functions such as memory elements.

A single FPGA/ASIC can also be used for both transmit and receive functions in a single transceiver.

In the present invention the FPGA or ASIC and associated rate adapting interfaces are designed for performing the transmission operations of:
i) inserting pilot data within the incoming binary data sequence for the purpose of channel transfer function estimation;
ii) encoding the resulting binary data sequence into serial complex numbers using different signal modulation formats;
iii) truncating the encoded complex data sequence into a number of equally spaced narrow band data;
iv) applying an inverse time to frequency domain transform such as an inverse fast Fourier transform (IFFT) for generating parallel complex or real valued time domain samples forming OOFDM symbols;
v) inserting a prefix in front of each symbol of step iii) said prefix being a copy of the end portion of the symbol;
vi) serialising the parallel samples into a long digital sequence; and the receiving operations of:
vii) deserialising the serial samples into parallel samples;
viii) synchronising the deserialisation function of step vii) so that the parallel samples originate from the same symbol;
ix) removing the unwanted prefix from the symbol;
x) applying a time to frequency domain transform such as a fast Fourier transform (FFT) generating parallel complex frequency domain values;
xi) detecting the pilot data and using it to estimate the channel transfer function and performing channel equalisation on the complex values generated in step x);
xii) decoding the parallel complex values obtained in step xi) to binary data values using the inverse of the encoding used in step ii);

The present invention also provides a method for synchronising all network elements (OLT/ONU) in a point-to-multipoint OOFDM PON by synchronising the clocks in the ONUs with the clock source in the OLT's transmitter.
by providing a clock source that generates a dedicated timing signal at the OLT and wherein a multiple or sub-multiple of said timing signal is transmitted along with the OOFDM data signal and wherein the data signal and the synchronisation clock signal occupy different parts of the frequency spectrum;
by distributing the synchronisation clock along with the OFDM data signal to all ONUs through the PON based on a passive optical splitter;
by separating the timing signal from the data signal in each ONU and processing said timing signal with simple electronics to generate the required receiver clocks.

Synchronising all network elements is essential for the network to achieve hybrid dynamic bandwidth sharing in the time domain via time slot allocation and/or in the frequency domain via subcarrier allocation. Synchronisation ensures that timeslots from different ONUs remain aligned and ensures that all subcarriers from all ONUs are orthogonal both of these being essential requirements for network operation.

As disclosed in FIG. 1(b), the OLT transmitter system generates the data signal and comprises the FPGA or ASIC, rate adapting interface (26) and the DAC. It further comprises a clock source (1) necessary for clocking the both the FPGA/ASIC and DAC. The clock source of frequency fₛ is fed via electrical power splitters (2-3) to frequency dividers/multipliers (4-6) to generate clocks for the FPGA/ASIC, the DAC and a synchronisation clock to be transmitted along with the OOFDM data signal.

The synchronisation clock signal passes through a RF gain section (7) and an optional band pass filter (BPF) (8). The signal exiting the DAC is sent to a RF gain section (9), and an optional low pass filter (LPF) (10). The signals exiting respectively the LPF (10) and the BPF (8) are combined in an electrical power combiner (11). As disclosed in FIG. 1(a) the signal then continues its path, as in typical point-to-multipoint PONs, through an electrical to optical modulator (12), optical link consisting of a feeder fibre (23), passive optical splitter (24) and distribution fibres (25). As disclosed in FIG. 1(c) the optical signal is then detected by an optical detector (13) in each ONU. It is then split through an electrical power splitter (14) into two branches, the first branch going through a low pass filter (15), to select the OOFDM data signal, and variable RF gain section (16) to the analogue to digital converter (ADC) and then via a rate adapting interface (27) to the FPGA/ASIC. The second branch going through a band pass filter (17), to select the synchronisation clock, and a variable RF gain section (18) to a clock regenerator (19). The clock regenerator significantly reduces the clock jitter and generates a clock at a multiple or sub-multiple of the synchronisation clock frequency. The clock regenerator sends said clock signal to an electrical power splitter (20), said splitter sending a first signal to the ADC via a first optional frequency divider (21) and a second signal through a second frequency divider (22) to the FPGA/ASIC. This set up allows accurate synchronisation between the OLT transmitter and all ONU receivers.

In such networks it is essential that the multiple optical network units (ONUs) sharing a common feeder fibre be highly synchronised such that there is no interference, at the optical line terminal (OLT), between upstream traffic originating from different ONUs. If a single ONU transmitter is not synchronised to the network it can corrupt all network traffic.

The transmission system can be any intensity-modulation and direct-detection (IMDD) or coherent system and the link can include optical amplifiers and other necessary components. It is preferably a simple optical amplifier-free optical link as represented in FIG. 1(a) for PON systems.

FIG. 1(a-c) represents the downstream direction in the PON, however the synchronous clocking solution provides clocks for both downstream and upstream transmission. The fact that the invention allows upstream transmissions to be synchronised is essential for the correct functioning of the point-to-multipoint OOFDM-based PON. For uplink transmission, the ONUs' transmitter clock signals are generated from the regenerated clock in a way similar to that of the ONU's receiver clocks, preferably the same ONU clocks being used for receiver and transmitter. In the OLT receiver, the clock signals are generated from the clock source used by the associated OLT transmitter, preferably the same OLT clocks being used for transmitter and receiver.

As OOFDM is based on sampling both digital and analogue signals at discreet time intervals the system can become highly complex if all sample based elements (DAC, ADC and FPGA/ASIC) do not operate at the same sampling rate or at least sub-multiples of a common sampling rate. If the DAC and ADC in the OOFDM transmitter and receiver respectively operate at the exact same sample rate this avoids the need for any complex digital signal processing to compensate for any sampling frequency offset. Also the FPGA/ASIC interfacing to the DAC and ADC must be clocked at a rate below the DAC/ADC sample rate due to the speed limitation of current digital logic, by selecting a clock rate for the FPGA/ASIC which is a sub-multiple of the sample rate and providing a suitable rate adapting interface allows the FPGA/ASIC to process parallel samples whilst maintaining the same overall sample throughput rate which is essential for correct system operation. For the transmitter the aforementioned rate adapting interface between the FPGA/ASIC and the DAC converts Y parallel samples at a rate X/Y parallel samples/s to X serial samples/s. In the receiver the rate adapting interface operates in reverse converting serial samples to parallel samples. It is therefore another objective of the present invention to define the detailed steps required to achieve synchronous clocking of all digital elements, specifically DACs, ADCs and FPGA/ASICs within a single point-to-multipoint OOFDM network, the sampling clock offset between all elements having a zero average value and very low maximum clock jitter.

The OOFDM system operates at a sampling rate of S samples/s and the OOFDM data signal is a baseband signal with a bandwidth of B Hz. In most applications, S can range from a few GS/s to as high as several tens of GS/s. The transmitted synchronisation clock has a frequency of f_{SYNCH} Hz. It is a requirement of the present invention that the data signal and the synchronisation clock signal occupy different parts of the frequency spectrum: this is the only restriction on the signal frequencies.

All clocks required in the OLT transmitter are derived from a single clock source operating at frequency f_{S}. To minimise complexity, f_{S} is related to the sample rate S by formula f_{S}=c·S Hz, wherein S is the sampling rate and c is a multiplier selected to provide signals of appropriate frequency, and has a value of at least 10⁻⁴ Preferably, f_{S} is selected as a small (sub)multiple of sampling rate S and c is therefore most preferably ranging between 0.2 and 6, more preferably between 0.5 and 2.

In the OLT transmitter system, the OOFDM transmitter block generates the data signal, it requires a sample clock for clocking the DAC at frequency f_{DAC}=f_{S}/n Hz, wherein n is of at least 10⁻⁴, preferably of from 0.2 to 6, more preferably of 0.5 to 2. The clock for the transmitter logic requires a clock at frequency f_{TX-LOGIC}=f_{S}/m wherein m is ranging between 10⁻² and 100, most preferably ranging between 0.5 and 75, more preferably between 1 and 50.

The source frequency f_{S} is preferably a small integer multiple of f_{DAC}. This allows f_{DAC} to be easily generated with a frequency divider.

The clock for the transmitter digital signal processing (DSP) logic, is preferably a sub-multiple of source frequency f_{S} and is generated with a frequency divider directly from f_{DAC} or from the clock source f_{S}.

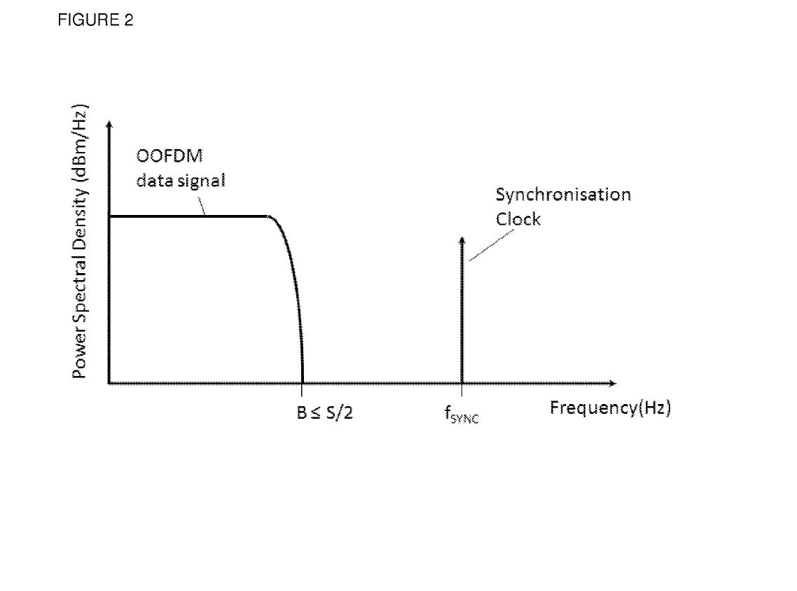

The synchronisation clock transmitted with the data has a frequency f_{SYNC} Hz selected to satisfy formula f_{SYNC}=p·f_{S} Hz, wherein p is of at most 10³, preferably of at most 20, more preferably of at most 5. It is a requirement of the present invention that the synchronous clock frequency f_{SYNC} be larger than the signal bandwidth B. This requirement allows easy separation of clock signal from data signal at the receiver using an appropriate filter. The combined OOFDM data and the synchronisation clock electrical signal spectrum is displayed in FIG. 2.

In the ONU's receiver the optical signal is detected by a photodetector and is converted into the electrical domain. Said electrical signal is then split by an electrical power divider in order to feed respectively the ONU receiver block and the clock regeneration circuit.

The synchronisation clock signal at the output of the BPF (17) feeds the clock regenerator circuit based on a phase-locked-loop (PLL). The received synchronisation clock contains a high level of jitter, that is filtered out by the PLL. A stable, clean, low jittered clock is thus produced: it is locked to the frequency of the received synchronisation clock.

The regenerated clock from the PLL operates at frequency f_{REG} that is related to f_{SYNC} by formula f_{REG} =x·f_{SYNC}, wherein x is selected to make f_{REG} suitable for generating the required receiver clocks and is of at least 10⁻³, preferably of from 0.2 to 6, more preferably of 0.5 to 2.

The ADC in the ONU's receiver requires a clock at frequency f_{ADC} and the receiver logic requires a clock at frequency f_{RX-LOGIC}. The PLL is preferably designed to ensure that f_{ADC}=(1/q)·f_{REG} and f_{RX-LOGIC}=(1/r)·f_{REG}. q is of at least 10⁻², preferably of from 0.2 to 6, more preferably of from 0.5 to 2. r is of at least 10⁻⁴, preferably of from 0.2 to 6, more preferably of from 0.5 to 2.

Table 1 lists all system clocks and related parameters and gives the relationship of the frequencies to the source clock frequency f_{S}.

TABLE 1

| | | | | | Most |
|---|---|---|---|---|---|
| | Frequency | | | Preferred | preferred |
| Signal/Parameter | (Hz) | Parameter | Range | range | range |
| Source clock | f_{S} | | | | |
| TX FPGA/ASIC clock | f_{TX-LOGIC} = f_{S}/m | m | 10⁻² to 100 | 0.5 to 75 | 1 to 50 |
| DAC clock | f_{DAC} = f_{S}/n | n | >10⁻⁴ | 0.2 to 6 | 0.5 to 2 |
| Synchronisation clock | f_{SYNCH} = p · f_{S} | p | <10³ | <20 | <5 |
| Regenerated clock | f_{REG} = x · p · f_{S} | x | >10⁻³ | 0.2 to 6 | 0.5 to 2 |
| ADC clock | f_{ADC} = (x · p/q) · f_{S} | q | >10⁻² | 0.2 to 6 | 0.5 to 2 |
| RX FPGA/ASIC clock | f_{RX-LOGIC} = (x · p/r) · f_{S} | r | >10⁻⁴ | 0.2 to 6 | 0.5 to 2 |
| Sample Rate | S = f_{S}/c | c | >10⁻⁴ | 0.2 to 6 | 0.5 to 2 |
| OOFDM signal | 0 to B (B ≦ S/2) | | | | |
| spectrum | | | | | |
| BPF centre frequency | f_{CENTRE} = p · f_{S} | | | | |
| LPF 3 dB bandwidth | B > f_{3 dB} > f_{SYNC} | | | | |

Note:
m, n, p, x, q, r and c are fixed multiplier/divider values

In a preferred embodiment according to the present invention, all clocks are produced with frequency dividers thereby requiring a single PLL in the clock regenerator block.

The present invention offers several technical advantages, such as listed below for example.
The difference between f_{SYNC} and B can be minimised to reduce the total bandwidth occupied by the transmitted signal. It must be kept in mind however that, the larger the frequency guard-band between B and f_{SYNC}, the lower the requirements on the filters required to separate the data and the synchronisation clock. A compromise between total bandwidth and ease of separation must therefore be selected. A realistic guard-band would be in the range of 25% to 100% of B.
The quality of the band-pass-filter designed to extract the clock from the received signal influences the system's performance. A narrow pass band is preferred as it reduces the phase noise of the filtered clock and makes it easier to minimise the jitter on the regenerated clock.
The low-pass-filter designed to extract the data signal from the received signal acts as an anti-aliasing filter as required by all sampling systems. It also removes the synchronisation clock signal so that it does not reduce the effective full-scale range of the ADC. If the synchronisation frequency is selected such that f_{SYNCH}=(w/2).S wherein w is an integer of at least 2, no aliasing products will fall within the OOFDM subcarrier frequencies thereby relaxing the stop-band requirements of LPF (15).

The power of the synchronisation clock relative to the power of the OOFDM data signal influences system performance and must therefore have an optimum value. The optical modulator has a maximum driving voltage. If the power of the clock signal is too high, the power in the data signal must be decreased to accommodate the clock. This reduces the system's performance through various mechanisms such as, for example, increased signal-to-noise ratio (SNR) required for achieving a specific BER. When the power of the clock signal is reduced, it is more susceptible to noise thereby exhibiting more phase noise at the receiver. It is thus harder to minimise the jitter on the regenerated clock. The optimum power ratio of the synchronisation clock and OOFDM data signal depends upon system parameters such as modulation format used and analogue/optical device characteristics and can therefore be optimised for each type of system.

In the present invention a procedure for determining the optimum clock and OOFDM signal power levels in an IMDD system is defined, for a point-to-multipoint network wherein the downlink with the highest loss is selected for the optimisation procedure. The procedure is also valid for coherent system. The optimisation procedure is defined as follows:
i) V_{MAX} is defined as the maximum peak-to-peak driving voltage of the optical intensity modulator, either directly modulated or externally modulated, V_{OOFDM} is defined as the peak-to-peak voltage of the OOFDM signal at the intensity modulator and V_{CLK} is defined as the peak-to-peak voltage of the clock signal at the intensity modulator. At a fixed intensity modulator bias condition, the maximum and minimum of values of V_{CLK}, in the range 0 to V_{MAX}, where the synchronisation clock are successfully recovered in the receiver are determined for different values of V_{OOFDM}, in the range 0 to V_{MAX}. By plotting the maximum and minimum of values of V_{CLK} against the associated values of V_{OOFDM}, a synchronisation region is defined indicating all possible combinations of V_{OOFDM} and V_{CLK} over which synchronisation can be achieved for a specific modulator bias condition. The modulator bias condition is adjusted until the synchronisation region obtained maximises the value of V_{OOFDM}.
ii) Select the minimum value of V_{CLK} within the synchronisation range that allows the maximum V_{OOFDM} range.
iii) With the modulator biased for the optimum synchronisation region and the amplitude of V_{CLK} set to that determined in step ii, the system BER is measured as a function of the amplitude of V_{OOFDM} varied over its full range.
iv) Determining the optimum value of V_{OOFDM} by selecting a value for V_{OOFDM} that minimises the BER and falls within the synchronisation region.

The present invention thus provides a method for optimising the OOFDM and clock power levels in an IMDD-based OOFDM transmission system that maximises system BER performance and minimises clock signal power.

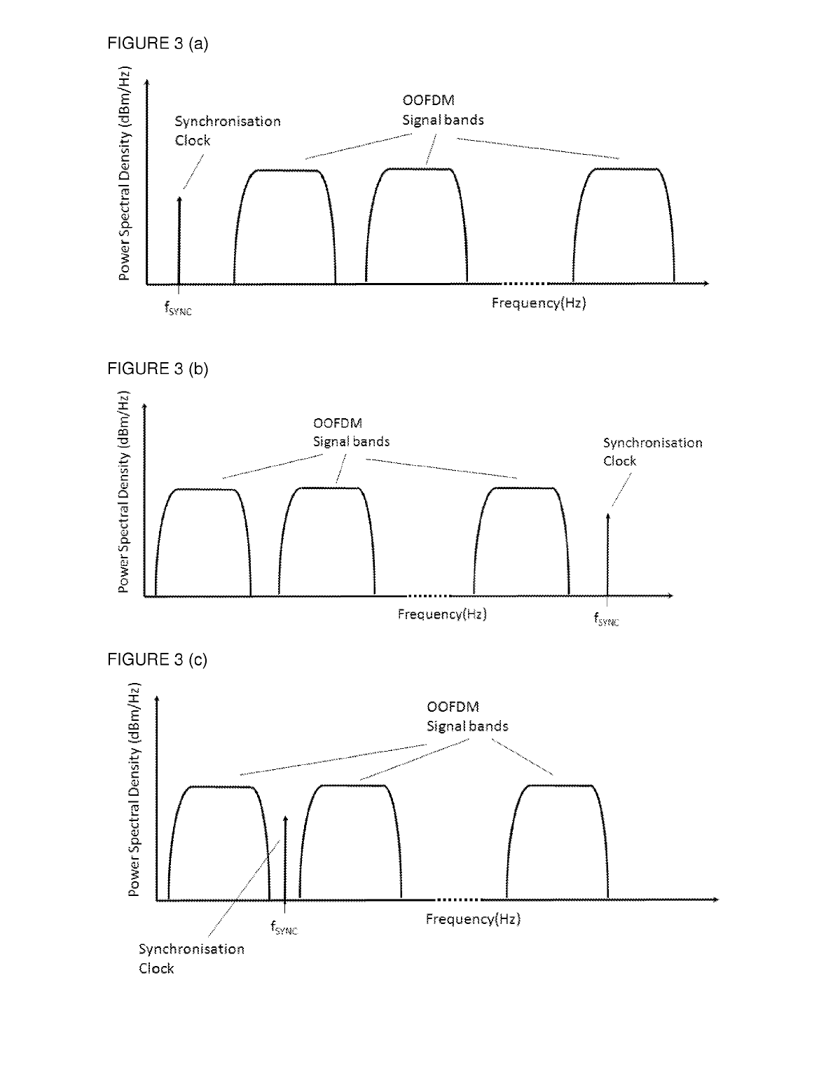

If desired, the OOFDM data signal can be modulated onto one or more radio frequency (RF) carriers to achieve multiband OOFDM, the restriction on the synchronisation clock now being that it does not fall within the OOFDM signal bands. By using an RF carrier an OOFDM system transmitting complex time-domain data can be realised as the real and imaginary parts of the IFFT output can be I/Q multiplexed onto the RF carrier. I/Q modulation/demodulation of an RF carrier can be performed in the analogue domain which will require two DACs and two ADCs respectively for the separate conversion of the real and imaginary signal parts, in this case for the same sample rate, spectral bandwidth and the line rate will be doubled compared to baseband signal transmission. I/Q modulation/demodulation can also be performed in the digital domain with direct DAC/ADC conversion to/from the modulated band, with or without employing conversion to/from an intermediate frequency (IF). For digital I/O modulation/demodulation the bandwidth requirements of the DAC/ADC will be at least twice that of the analogue I/Q modulation/demodulation case. The clocks for the DACs, ADCs and the RF carrier up-converting/down-converting frequencies can all be generated from the master clock source in the OLT and recovered clocks in the ONUs. Due to the synchronised carrier frequencies there is no carrier frequency offset between transmitter and receiver to be compensated after the up-conversion and down-conversion of the OOFDM signal. The multiband OOFDM signal now occupies more of the available fibre bandwidth thus increasing the total network capacity. However the sample rate of the DAC(s) associated with each OOFDM band only needs to support sufficient bandwidth for each OOFDM band. By modulating the OOFDM signal onto one or more RF carriers, spectrum can be made available at low frequencies below the lowest frequency band. This can be used for the synchronisation clock as a frequency preferably as low as 10 MHz can be used. For example if the RF carrier is 2.5 GHz and the OOFDM signal's double-sideband bandwidth is 4 GHz, the frequency range from 0 to 500 MHz is available for the transmission of the synchronisation clock. If a synchronisation clock has a frequency of less than 100 Mz, preferably less than 20 MHz it can easily be extracted at the ONU using a low pass electrical filter. The synchronisation clock signal can also be located above or in the guard band between any OOFDM bands and filtered out using an electrical band-pass filter in the ONU. FIG. 3(a-c) shows examples of the electrical signal spectrum of multiband OOFDM, in FIG. 3(a) the clock is located below all bands, in FIG. 3(b) the clock is located above all bands and in FIG. 3(c) the clock is located between two OOFDM bands.

Each ONU decodes a single OOFDM band. The decoded band can be selected by generating a suitable RF frequency according to the RF carrier of the required band. The OOFDM receiver can either employ a) I/Q analogue demodulation direct to baseband with two ADCs, or (b) down-conversion to an IF frequency, analogue-to-digital conversion by a single ADC and I/Q demodulation in the digital domain. The RF frequency used to select the desired OOFDM band is generated with a programmable frequency synthesiser such as typically used in band selecting radio receivers, where the reference clock for the frequency synthesiser is generated from the recovered ONU clock. The same clock generated for the down-conversion of the selected OOFDM band is also used for up-conversion when generating the corresponding upstream OOFDM band. Also the sample rate of the ONUs DAC(s) and ADC(s) associated with each OOFDM band only needs to support sufficient bandwidth for the required OOFDM band.

The present invention thus also discloses a multiband, point-to-multipoint, OOFDM network characterised in that ONUs can selectively tune to any OOFDM band by simply generating the appropriate RF carrier frequency via a frequency synthesiser which is synchronised to the network.

In a single point-to-multipoint multiband OOFDM network there can be OOFDM bands of different widths however to simplify implementation an ONU would be designed for a fixed width OOFDM band.

The ability of an ONU to select from multiple OOFDM bands could allow one or more OOFDM bands to be dedicated to broadcast services. To receive the broadcast service the ONU tunes to the broadcast OOFDM band as needed. Band selective ONUs can also allow effective bandwidth management by varying the number of ONUs allocated to each band, by reducing the number of ONUs allocated to the same band the average and peak bit rate per ONU is increased, similarly by increasing the number of ONUs allocated to the same band the average and peak bit rate per ONU is decreased. OOFDM bands can therefore be allocated dynamically according to changing user service demands.

### COMPARATIVE EXAMPLE

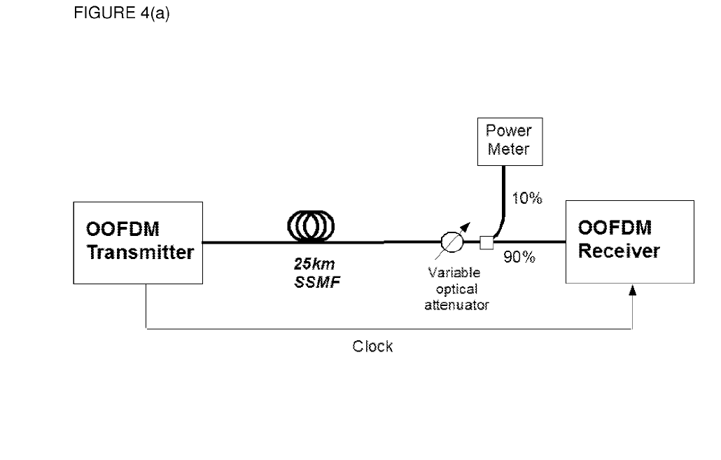

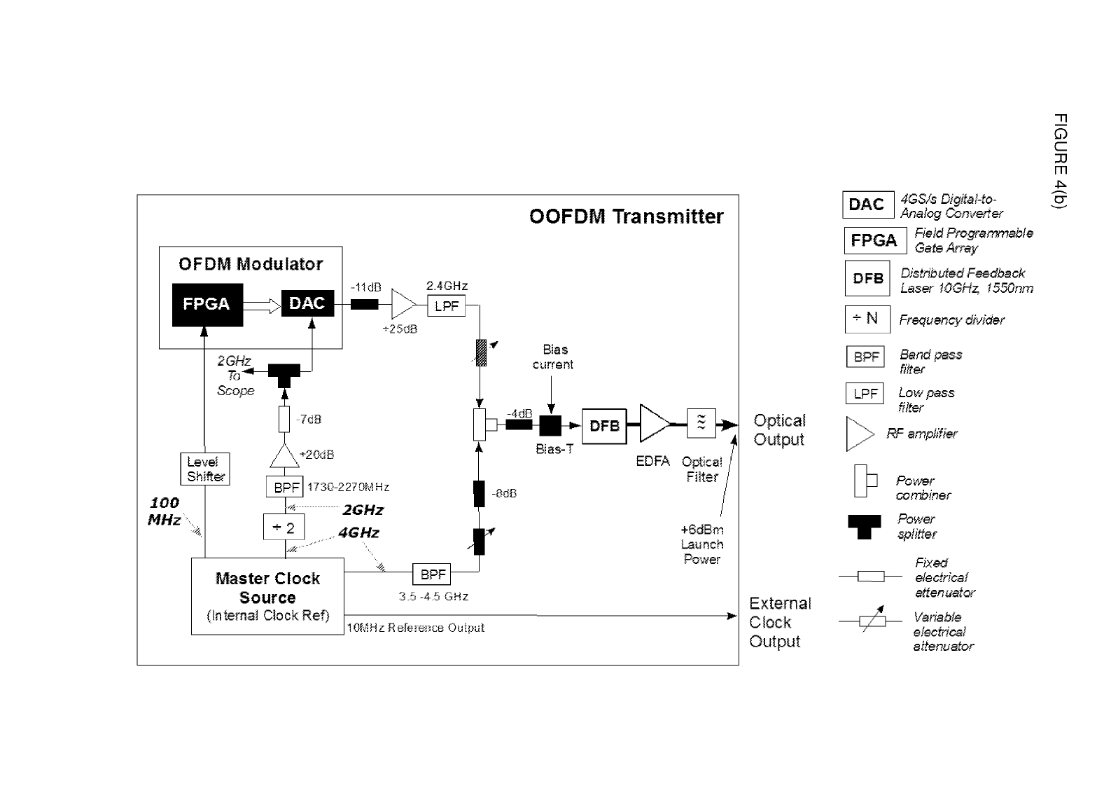

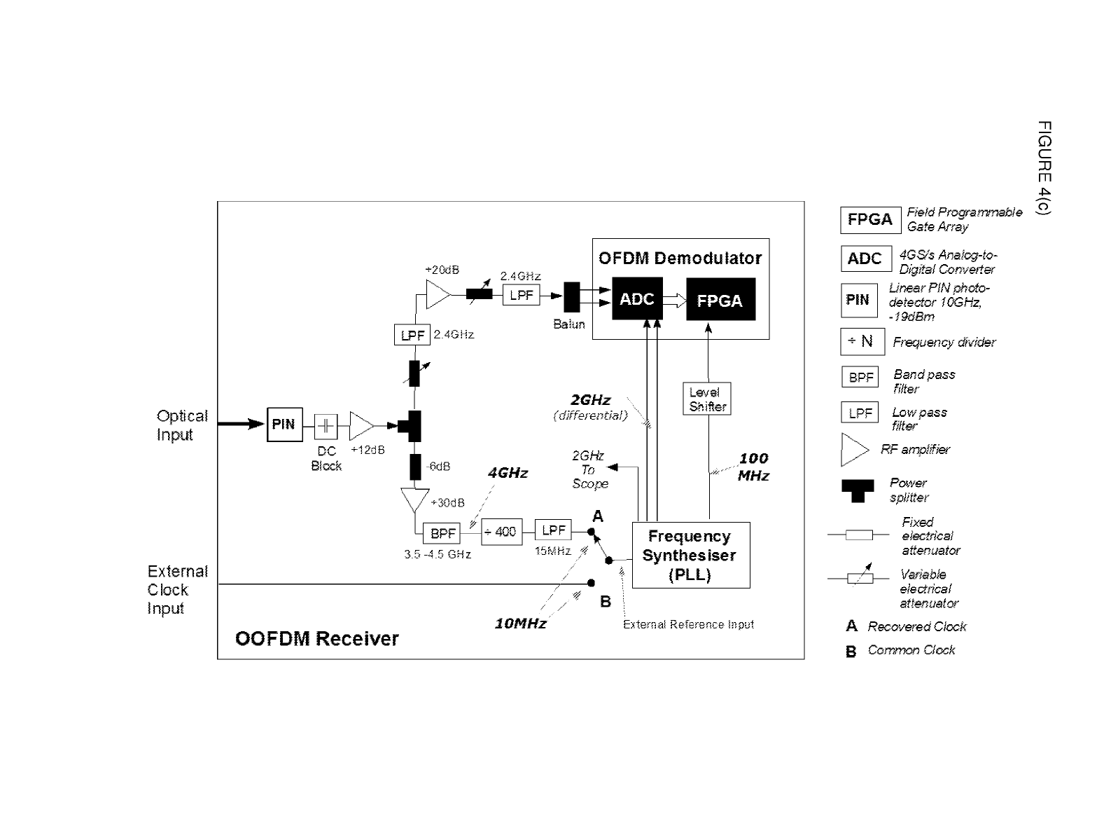

An experimental demonstration and optimisation of a synchronously clocked real-time OOFDM system was performed using the set up of FIG. 4(a-c). The clock frequencies and related parameters employed are given in Table 2, and Table 3 lists all other system parameters. At the transmitter, a frequency synthesiser functioned as the master clock source operating at 4 GHz with an accuracy of ±3 ppm. This clock was also internally pre-scaled to provide a 100 MHz clock for the transmitter FPGA (m=40), with an OOFDM symbol rate of 100 MHz. One 4 GHz output from the frequency synthesiser was divided by 2 (n=2), band-pass filtered and amplified to generate a 2 GHz sine wave signal for the 4 GS/s DAC. The DAC consisted of four interleaved converters so the 2 GHz clock was further subdivided to 1 GHz internally in the DAC. A second 4 GHz output was band-pass filtered and variably attenuated to provide the dedicated 4 GHz synchronization clock signal (p=1). The amplitude of the synchronization clock was adjusted directly with the synthesiser's output level adjustment and the variable electrical attenuator was also used to extend the adjustment range. The electrical OFDM signal from the DAC was amplified, low-pass filtered and variably attenuated before combination with the synchronization clock via a resistive RF coupler. The signal from the coupler was attenuated and combined via a bias-T with an optimised DC bias current to directly modulate a 10 GHz, 1550 nm DFB laser. After boosting the DFB output power with an EDFA and optical band-pass filtering to reduce ASE, the optical launch power was set at 6 dBm. The 25 km standard single mode fibre (SSMF) had an 18 ps/nm/km chromatic dispersion parameter and a linear loss of 0.2 dB/km at 1550 nm.

At the receiver a variable optical attenuator was used to control the received optical power prior to a 12.4 GHz linear PIN detector. The electrically amplified output of the PIN was split by a 2-way resistive RF splitter. One output that fed the OOFDM receiver was low-pass filtered to remove the clock signal and provide anti-aliasing filtering. Having been amplified and suitably attenuated, the signal was then fed to the differential input of the 4 GS/s ADC via a balun. As the received optical power varied, electrical gain prior to the receiver's ADC was also adjusted accordingly to optimise the signal amplitude at the ADC input. Automatic gain control (AGC) was implemented by measuring the received signal amplitude, and controlling a variable gain amplifier (VGA). The second output was amplified by a high gain amplifier (30 dB) and band-pass filtered to extract only the 4 GHz synchronisation clock signal. A pre-scaler reduced the clock frequency to 10 MHz, which was then low-pass filtered and used as the external reference for a clock synthesizer generating the 2 GHz clock for the receiver's ADC (effectively x=0.5 and q=1), this clock was also pre-scaled to generate the 100 MHz receiver FPGA clock (r=20). In the present system setup, the clock synthesizer in the receiver effectively operated as a PLL, such clock synthesizer could, however, be easily replaced by a low-cost, fixed frequency PLL plus a 1/20 prescaler.

To configure the system to also operate with a common clock configuration, the 10 MHz reference output from the transmitter's clock synthesiser was directly connected to the external reference input of the receiver's frequency synthesiser. This is illustrated in FIG. 4(c) where the external reference input is connected to point A to use the recovered clock and to point B to use the common clock. Changing between the recovered clock and the common clock in this way enabled a direct comparison of the two clocking methods under exactly the same system setup and operating conditions.

TABLE 2

| | | Example | |
|---|---|---|---|
| Signal/Parameter | Frequency (Hz) | Frequency (GHz) | |
| Source clock | f_{S} | 4 | |
| Transmitter FPGA/ASIC clock | f_{TX-logic} = f_{S}/m | 0.1 | (m = 40) |
| DAC clock | f_{DAC} = f_{S}/n | 2 | (n = 2) |
| Synchronisation clock | f_{SYNCH} = p · f_{S} | 4 | (p = 1) |
| Regenerated clock | f_{REG} = x · p · f_{S} | 2 | (x = 0.5) |
| ADC clock | f_{ADC}= (x · p/q) · f_{S} | 2 | (q = 1) |
| Receiver FPGA/ASIC clock | f_{RX-LOGIC} = | 0.1 | (r = 20) |
| | (x · p/r) · f_{S} | | |
| Sample Rate | S = f_{S}/c | 4 | (c = 1) |

| | | |
|---|---|---|
| OOFDM signal spectrum | 0 to B (B ≦ S/2) | 0 to 2 |
| BPF center frequency | f_{CENTER} = p · f_{S} | 4 |
| LPF 3 dB bandwidth | B > f_{3 dB} > f_{SYNC} | 2.4 |

Note:
m, n, p, x, q, r and c are fixed multiplier/divider values

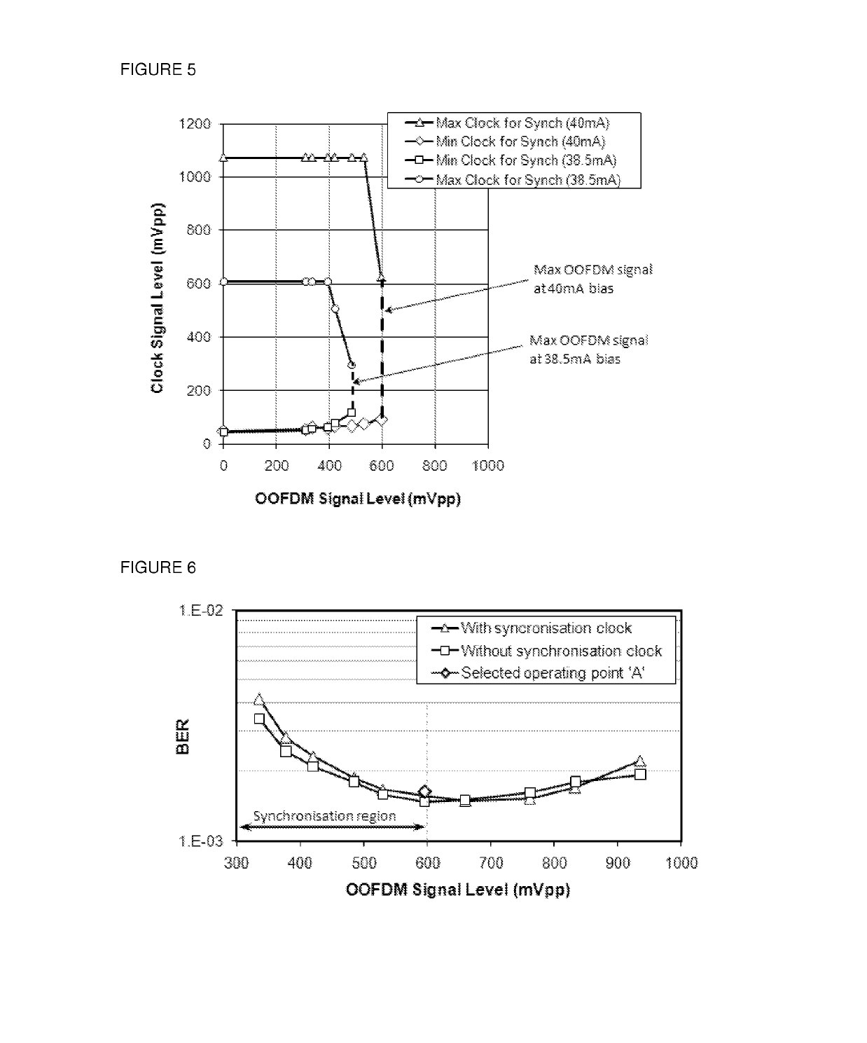

The synchronously clocked OOFDM system was optimised using the method of the present invention. FIG. 5 shows the obtained synchronisation region in terms of the allowed peak-to-peak voltage levels of the OOFDM signal and Clock signal. A 40 mA bias current for the directly modulated DFB laser gave a synchronisation region which maximised the value of the OOFDM peak-to-peak voltage. A clock signal amplitude of 100 mVpp was then selected as the minimum level for providing the maximum range for V_{OOFDM}. With bias current at 40 mA and V_{CLK} set to 100 mVpp, the system BER measured at varying levels of the OOFDM signal was determined and is shown in FIG. 6. FIG. 6 shows that the OOFDM signal level had an exploitable operating region from approximately 530 mVpp to 760 mVpp where the OFDM signal power-dependent BER variation was negligible. As the maximum value of V_{OOFDM} for which synchronisation was achieved was of 600 mV thus falling within the exploitable operating region, it was selected as the optimum value for V_{OOFDM}. The optimum operating point was therefore determined as bias current=40 mA, V_{CLK}=100 mVpp and V_{OOFDM}=600 mVpp. FIG. 6 also shows the variation of BER against V_{OOFDM} measured without the synchronisation clock and using the common clock configuration. It can be seen that the presence of the synchronisation clock at the selected level had almost negligible impact on the system BER performance within the aforementioned exploitable operating region.

The present invention thus provides a method for optimising the OOFDM and clock power levels in an IMDD-based OOFDM transmission system that maximises system BER performance and minimises clock signal power.

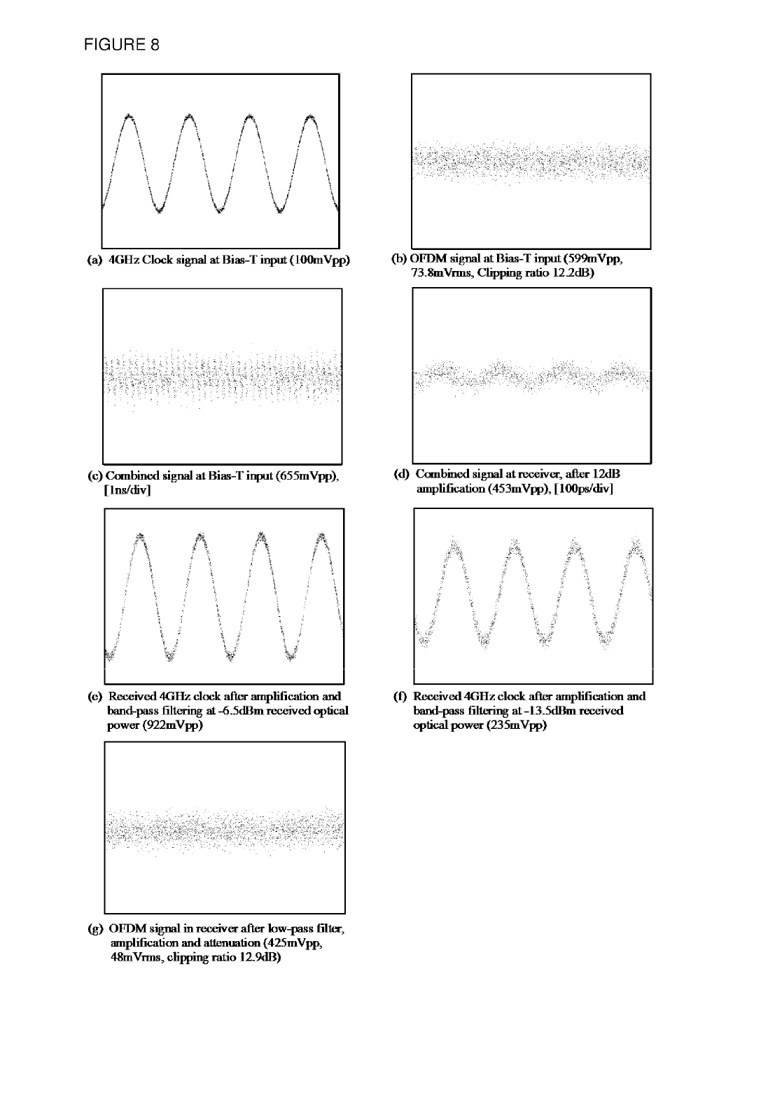

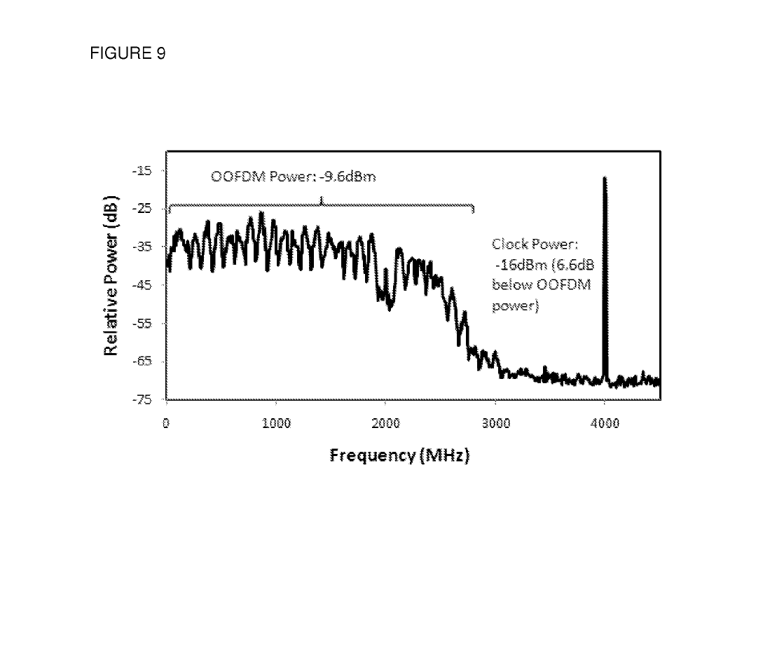

The waveforms of various signals within the OOFDM system under the aforementioned optimised conditions are given in FIG. 8(a-g). The transmit signal spectrum of the combined electrical OFDM signal and clock signal at the input of the bias-T in the transmitter is given in FIG. 9. At the selected operating conditions, the RF signal powers at the bias-T input were approximately −16 dBm for the synchronisation clock and −9.6 dBm for the OFDM signal. The synchronisation clock power was therefore 6.4 dB lower than the power of the OFDM signal.

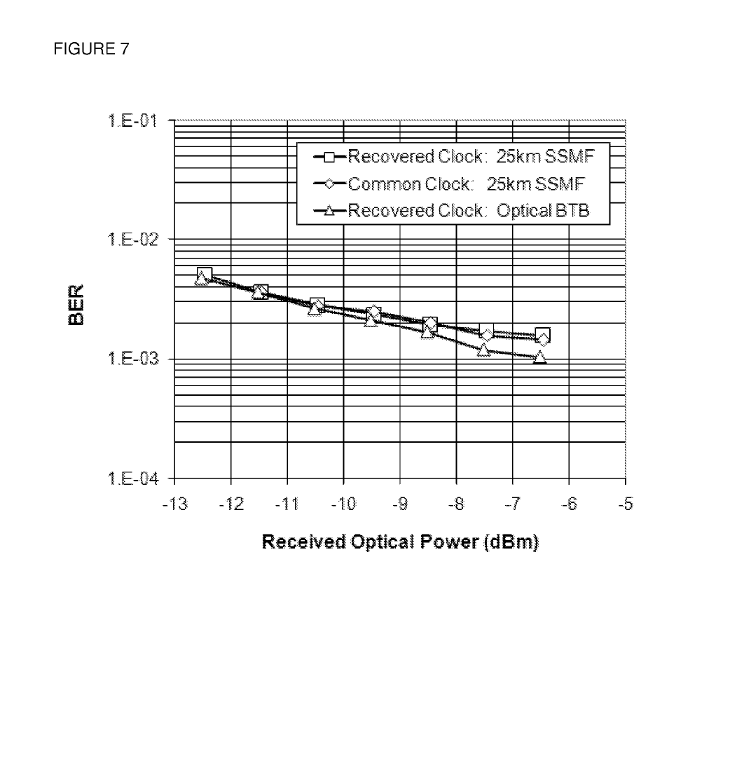

For 11.25 Gb/s over 25 km SSMF OOFDM signal transmission in the DML-based IMDD system under the identified optimum operating conditions, the system BER performance as a function of received optical power is plotted in FIG. 7 for both the common clock configuration and the synchronous clock configuration. The results clearly show that the BER performance of these two cases are identical, showing that the optimisation method allows a high quality clock to be recovered in the receiver whilst minimising the transmitted clock power, and more importantly, that the optimisation did not result in system BER or optical power budget degradation.

TABLE 3

| Parameter | Value | |
|---|---|---|
| Total number of IFFT/FFT points | 32 | |
| Data-carrying subcarriers | 15 | |
| n-th subcarrier frequency | n × 125 | MHz |
| Modulation format on all subcarriers | 64-QAM | |
| DAC & ADC sample rate | 4 | GS/s |
| DAC & ADC resolution | 8 | bits |
| Symbol rate | 100 | MHz |
| Samples per symbol (IFFT) | 32 samples (8 ns) | |
| Cyclic prefix | 8 samples (2 ns) | |
| Total samples per symbol | 40 samples (10 ns) | |
| Error count period | 88,500 symbols | |
| | (7965000 bits) | |
| Raw signal bit rate | 11.25 | Gb/s |
| Net signal bit rate (cyclic prefix 25%) | 9 | Gb/s |
| DFB laser wavelength | 1550 | nm |
| DFB laser modulation bandwidth | 10 | GHz |
| DFB laser bias current | 40 mA^{a} (42 mA max) | |
| DFB laser driving voltage | 655 mVpp^{a, b} (900 mVpp max) | |
| EDFA output power | 10 | dBm |
| PIN detector bandwidth | 12.4 | GHz |
| PIN detector sensitivity | −19 | dBm^{c} |

| | |
|---|---|
| SSMF dispersion parameter at 1550 nm | 18 ps/(nm · km) |

^{a}Optimised value
^{b}Combined OFDM signal and clock signal
^{c}Corresponding to 10 Gb/s non-return-to-zero data at a BER of 1.0 × 10⁻⁹

1.-13. (canceled)

14. A synchronously clocked point-to-multipoint OOFDM passive optical network transmission system that comprises:
A. transmitter systems, each comprising:
a) a field-programmable gate array (FPGA) or an application-specific integrated circuit (ASIC) providing high speed digital logic-based DSP for OOFDM signal generation;
b) parallel to serial rate adapting interface between FPGA/ASIC and DAC;
c) a digital to analogue converter (DAC);
d) a clock source;
e) an optical modulator;
B. receiver systems comprising:
a) an optical detector;
b) an analogue to digital converter (ADC);
c) serial to parallel rate adapting interface between ADC and FPGA/ASIC;
d) a field-programmable gate array (FPGA) or an application-specific integrated circuit (ASIC) providing high speed digital logic-based DSP for OOFDM signal decoding.

15. A method for synchronizing clocks in the transmitters and receivers of the and multiple optical networks (ONUs) in a point-to-multipoint optical orthogonal frequency division multiplexing (OOFDM) network that comprises the steps of:
a) providing a clock source that generates a dedicated clock signal at the optical line terminal (OLT), wherein a multiple or sub-multiple of said clock signal is transmitted along with the OOFDM data signal, wherein the clock rate for the FPGA/ASIC is a sub-multiple of the sample rate, and wherein the data signal and the synchronization clock signal occupy different part of the frequency spectrum;
b) distributing the synchronization clock along with the OOFDM data signal to all the ONUs through the PON based on a passive optical splitter:
c) in the ONU's receiver, detecting the optical signal by a photodetector, converting it into the electrical domain and splitting it with an electrical power divider in order to feed respectively the ONU receiver block and the clock regeneration circuit; and
d) retiming said clock signal with simple electronics to generate the receiver clocks.

16. The method of claim 15 wherein all clocks required in the OLT are derived from the single clock source operating at frequency fₛ, and wherein the clock source operates at a frequency fₛ=c.S Hz wherein S is the sampling rate and c has a value of at least 10⁻⁴, preferably ranging between 0.2 and 6, more preferably between 0.5 and 2.

17. The method of claim 15 wherein the sample clocking for the DAC, f_{DAC}=fₛ/ⁿ Hz, wherein n has a value of at least 10⁻⁴, preferably 0.2 to 6, more preferably of from 0.5 to 2 and the clock for the transmitter logic f_{TX-LOGIC}=fₛ/m wherein m is ranging between 0.01and 100, preferably between 0.5 and 85, more preferably between 1 and 50.

18. The method of claim 15 wherein the synchronization clock has a frequency f_{SYNC}=p.fₛ HZ wherein p is an integer of at most 1000, preferably of at most 20 and more preferably of at most 5.

19. The method of claim 15 wherein the synchronous clock frequency f_{SYNC} is outside the signal bandwidth for a single baseband OPFDM signal frequency band, or falls in a guard band between OOFDM bands, below the lowest OOFDM signal frequency band or above the highest OOFDM signal frequency band for a signal spectral range consisting of multiple OOFDM bands.

20. The method of claim 15 wherein, in the ONU receivers, the clock signal is separated from the data signal using a low pass, high pass or band pass filter.

21. The method of claim 15 wherein, in the ONU receivers, the synchronization clock signal feeds the clock regenerator circuit based on a phase-locked-loop and wherein the regenerated clock operates at frequency f_{REF}=z.f_{SYNC} wherein x has a value of at least 10⁻³ and preferably ranges between 0.2 and 6, more preferably between 0.5 and 2.

22. The method of claim 15 wherein, in the ONU receiver, the ADC requires a clock at frequency f_{ADC}=1/q.f_{REF} wherein q is of at least 0.01 and preferably ranges between 0.2 and 6, more preferably between 0.5 and 2 and r has a value of at least 10⁻⁴ and preferably ranges between 0.2 and 6, more preferably between 0.5 and 2.

23. The method of claim 15 further comprising the generation of all necessary clocks to synchronize the clocked components including DAC, ADC, FPGA and ASIC within all network elements connected to a point-to-multipoint OOFDN network.

24. The method of claim 15 wherein the OOFDM and clock power levels are optimized in OOFDM transmission system for maximizing system BER performance and minimizing clock signal power.

25. The method of claim 15 wherein each ONU selectively tunes to any OOFDM signal band by generating the appropriate down converting RF carrier frequency via a frequency synthesizer which derives its reference clock input from the regenerated clock, allowing bandwidth management by dynamically allocating ONUs to different bands based on end-users' service requirements, and wherein the average bandwidth available to each ONU is controlled by varying the number of ONUs per band.

26. Use of the apparatus of claim 14 to achieve point-to-multipoint downstream and upstream transmission through synchronous clocking between OLT and ONUs in point-to-multipoint optical orthogonal frequency division multiplexing passive optical network transmission systems, said transmission being based on bandwidth sharing in the time domain or in the frequency domain, or in both time and frequency domains.
